(19) United States
(12) Patent Application Publication
(10) Pub. No.: US 2005/0064761 A1
(43) Pub. Date: Mar. 24, 2005

(54) Induction heater coupling device and method

(75) Inventor: Donald Stanford, Norway, ME (US)

Correspondence Address: BAKER & HOSTETLER LLP, Washington Square, Suite 1100, 1050 Connecticut Avenue, N.W., WASHINGTON, DC, 20036, US

(73) Assignee: SPX Corporation

(21) Appl. No.: 10/667,506

(22) Filed: Sep. 23, 2003

(51) Int. Cl. H01R 11/00; H01R 33/945

(52) U.S. Cl. 439/577

(57) ABSTRACT

A coupling fitting for attaching induction heater tooling to an RF induction heater uses combined RF electrical current and coolant fluid lines. The coupling fitting incorporates an o-ring seal to maintain a drip-free coolant path and a threaded accessory to urge the fitting halves together. The coupling fitting affixes each end of the tubing to be joined to a fitting half, so assembly and disassembly applies force to the two fitting halves instead of the tubing. The joint between each tube and its associated fitting half may be soldered, brazed, or attached by another permanent process.

### FIELD OF THE INVENTION

The present invention relates generally to electrical connectors. More particularly, the present invention is directed to combined fluid coolant and radio frequency energy couplers.

### BACKGROUND OF THE INVENTION

It is known in the art that conventional coupling devices for connecting piping and related conductors for water and other fluids, such as flare fittings and compression fittings, which are in some cases substantially similar to common plumbing components, can fail after a number of cycles of assembly and disassembly, thereafter exhibiting leakage. This phenomenon is particularly noticeable when the plumbing components are used in industrial environments where assembly and disassembly can be expected to occur indefinitely and at frequent intervals.

An example of such an environment is the apparatus employed for manufacturing in processes involving induction heating. In induction heating applications, plumbing components or components similar thereto are used to apply radio frequency electromagnetic energy (RF) to a workpiece to generate heat while also removing waste heat with a coolant fluid. The presence of leaking coolant fluid is likely to be incompatible with the application of RF, which application generally involves inducing eddy currents in metallic or semiconductor materials to heat the materials as part of a manufacturing process.

Induction heating uses an RF generator, termed an induction heat station, that outputs RF energy via a fitting that mates to the ends of, for example, a copper tube that forms a loop. The copper tube, which may in some instances be formed into a multiple-turn coil to increase inductive coupling, can be referred to as tooling. The tooling may be positioned around the perimeter of or adjacent to a zone of a conductive or semiconductive object or material undergoing manufacture, referred to as the workpiece, in order make it possible to induce in the zone of the workpiece an electromagnetic field that oscillates at an RF rate.

The conductive zone in the workpiece constitutes a shorted-turn secondary of a transformer of which the tooling is the primary. That is, when RF power is applied, an alternating electromagnetic field is established in that zone, which induces alternating current in any conductive or semiconductive material in the zone. The inherent resistance of the material from which the workpiece is made generates heat in quantities sufficient for many manufacturing operations, including heat treating, welding, brazing, soldering, softening of high-temperature adhesives, remelting of high-purity silicon forming a boule, and a number of other operations.

Typically, couplings comprise the joints between the induction heating station and the tooling, so that one tooling unit can be exchanged for others of different performance for different tasks. Often water or another heat transfer fluid travels through the tooling to serve as a heat exchange medium, the presence of which can be desirable because of heat caused by resistive losses within the tooling as well as heat coupled from the workpiece.

Conventional coupling devices, such as flare fittings and compression fittings, sometimes suffer from wear and/or breakage when used to provide the connection between an induction heating station and its tooling. In a connection using a pressure fitting such as a flare fitting or a compression fitting, an internal shoulder of a nut makes metal-to-metal contact with a tooling face formed by shaping the end of the tubing into a cone (flare fitting) or with an inserted, biconic male sleeve placed over the tubing and crushed inward by mating female tapers on a fixed element and on a removable nut (compression fitting).

Such designs depend on the effectiveness of the metal-to-metal pressure fitting to form a reliable, leak-free coolant joint, as well as a reliable electrical joint to allow RF to be effectively coupled into the tooling. These pressure fitting designs are satisfactory for pure plumbing applications, in which the expected medium to be transported is potable water and the anticipated number of assembly/disassembly cycles over the life of the apparatus is a relative handful. Applied to induction heating applications, such fittings can perform well during initial use, successfully coupling not only cooling water but also significant RF currents.

However, a multiplicity of removal/reattachment cycles can cause cumulative wear that degrades the performance of various parts, such as the tapered contact surfaces through which pressure is applied and through which a conductive path for RF energy is established. These surfaces lose their original effectiveness with repeated mechanical cycling, as the initial resilience and deformation capacity required for effective seals in metal-to-metal joints are exhausted and torque applications previously effective become insufficient. Commonly observed failures in such joints include both leakage through incomplete seals and resistive heating and its associated deformation and loss of temper in the joined faces. The thread faces of the rotatable female fittings and the static male fittings to which pressure is applied by tightening the joints can wear out as well, but are subject to distributed loads that reduce specific forces and can be lubricated, such as with polytetrafluoroethylene (PTFE, sold under such trade names as Teflon® and Dyneon™) in tape or other form, to reduce friction, or can be redesigned to improve their wear profiles.

The RF frequencies typically involved in induction heating are comparatively low, resulting in negligible skin effect, so it may be assumed that the electrical current density at the mating faces of the joining fittings is essentially an inverse function of the effective contact cross section in the contact region. Effective contact cross section is determined by available mating face area, smoothness, and normal force between the contact surfaces. The density of the electric current passing through the resistive materials comprising the joint, which materials are commonly copper and brass, translates to heat density, which represents power loss from the induction heating task.

Accordingly, it would be desirable to provide a combined RF electrical current and coolant fluid coupling apparatus and method that reduces wear on the copper tubing comprising the tooling itself, as well as on any components mechanically bound to the copper tubing.

### SUMMARY OF THE INVENTION

The foregoing needs are met, to a great extent, by the present invention, wherein in one aspect an apparatus is provided that in some embodiments presents a coupling apparatus that establishes a watertight joint and a low resistance electrical joint that together can be assembled and disassembled with low wear, can have the coolant fluid seal renewed by replacement of an o-ring, and can be removed and replaced without appreciable damage to the tooling of which the coupling apparatus forms a part.

In accordance with one embodiment of the present invention, a coupling fitting for coolant fluid and RF electrical current coupling comprises a fitting body having a fitting body longitudinal axis, having a fitting body mating face generally perpendicular to the longitudinal axis of the fitting body, having a fitting body through hole generally concentric with the fitting body longitudinal axis, and having an external provision for mating; a sleeve having a sleeve longitudinal axis, having a first sleeve mating face perpendicular to the sleeve longitudinal axis and proximal to the fitting body mating face, having a second sleeve mating face perpendicular to the sleeve longitudinal axis and distal to the first fitting body mating face, and having a sleeve through hole generally concentric with the sleeve longitudinal axis; and a nut having a nut longitudinal axis, having an internal nut face perpendicular to the nut longitudinal axis and proximal to the second sleeve mating face when assembled, having a nut through hole generally concentric with the nut longitudinal axis, and having an internal provision for mating compatible with the external provision for mating of the fitting body. In this embodiment of the present invention, the sleeve is grooved with a coaxial recess on the face that joins to the fitting body, and an o-ring interposed in the joint establishes a fluid seal.

In accordance with another aspect of the present invention, an apparatus and method for coupling fluid-filled electrical conductors comprises means for assembling and disassembling a fluid-filled coupling fitting first half and a fluid-filled coupling fitting second half with continuous helical screw threads; means for establishing a low electrical resistance across a coupling interface between fluid-filled electrical conductors through the use of a normal force between mating surfaces of a fluid-filled coupling fitting first half and a fluid-filled coupling fitting second half; and means for sealing a coupling interface against fluid leakage with a gasket affixed to a fluid-filled coupling interface first half and surrounding the fluid coupling interface, where the gasket is urged against a mating surface surrounding a fluid passage in a fluid-filled coupling fitting second half.

In accordance with yet another aspect of the present invention, a method for coupling fluid-filled conductors comprises the steps of securing a first coupling fitting half to a first conduit; securing a second coupling fitting half to a second conduit; placing an o-ring type gasket into a fitted groove in the first coupling fitting half; assembling the first and second coupling fitting halves; and urging the first and second coupling fitting halves together to establish a joint with low electrical resistance and low fluid leakage.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded view of an exemplary coupling device in accordance with the present invention.

FIG. 2 is a section view of the exemplary sleeve of FIG. 1.

FIG. 3 is a section view of the nut of exemplary FIG. 1.

FIG. 4 is a section view of the exemplary fitting body of FIG. 1.

FIG. 5 is a section view of an exemplary alternative conduit mounting configuration.

FIG. 6 is a section view of an exemplary alternative o-ring configuration.

### DETAILED DESCRIPTION

The invention will now be described with reference to the drawing figures, by way of non-limiting examples in which like reference numerals refer to similar parts throughout.

In an embodiment in accordance with the present invention, a coupling fitting for attaching induction heater tooling to an RF induction heater uses combined RF electrical current and coolant fluid lines. The coupling fitting incorporates an o-ring seal to maintain a drip-free coolant path and a threaded accessory to urge the fitting halves together. A fitting half is affixed to each tubing end to be joined, so assembly and disassembly apply force to the two fitting halves. The joint between each tube and its associated fitting half may be soldered, brazed, or attached by another permanent process. Alternative implementations may allow use with an induction heater that uses a manifold in place of a feed tube, as well as the use of self-sealing fittings to reduce drainage during disassembly and quick-release fittings in place of screw threads.

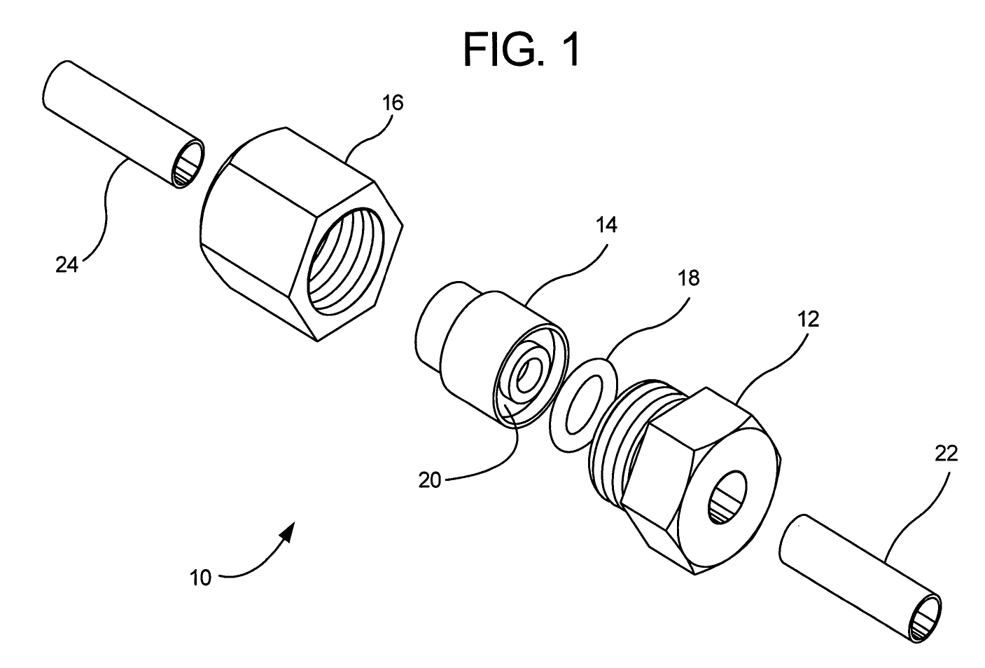

Shown in FIG. 1 is an exploded view of an exemplary coupling fitting 10 in accordance with the present invention. The coupling fitting 10 includes a fitting body 12, a sleeve 14, and a nut 16.

In an exemplary embodiment, when being assembled for operation, an o-ring 18 is placed in a groove 20 in the sleeve 14, a first conduit 22 is bonded within the fitting body 12, and a second conduit 24 is bonded within the sleeve 14. In the exemplary embodiment of the present invention, the fitting body 12, the sleeve 14, and the nut 16 are made from brass and the first and second conduits 22 and 24, respectively, are made from copper tubing. Assembly of the first and second conduits 22 and 24, respectively, to the fitting body 12 and the sleeve 14 in the exemplary embodiment is by soldering. It should be appreciated however, that other materials may be used which exhibit relatively similar properties to brass or copper, as desired. Also, other forms of bonding or adhering the various parts to each other may be contemplated, for example, ultrasonic welding, pressure fitting, etc., without departing from the spirit and scope of this invention.

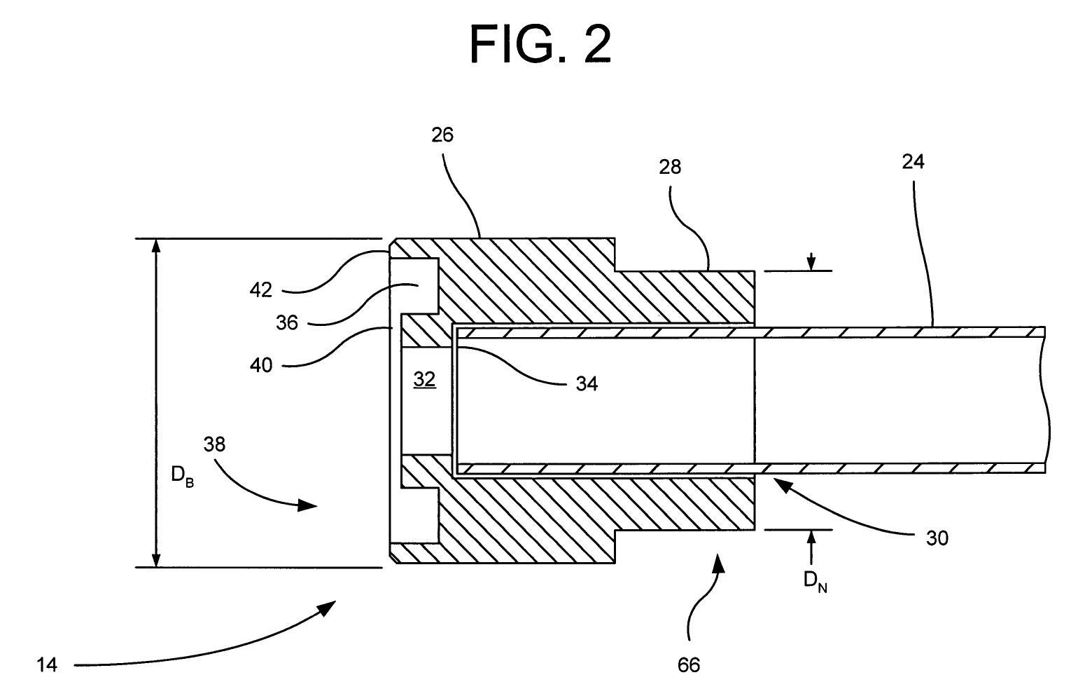

Shown in FIG. 2 is a section view of the exemplary sleeve 14. The exemplary sleeve 14 includes a sleeve body 26 and a sleeve neck 28. In the preferred exemplary embodiment of the present invention, the sleeve body 26 has a body diameter D_{B} that is greater in size than a neck diameter DN of the sleeve neck 28.

The exemplary sleeve 14 includes a first bore 30 on its axis that extends part of the way through the length of the exemplary sleeve 14. The first sleeve bore 30 accommodates a nut-side conduit 24. The exemplary sleeve 14 includes a second sleeve bore 32, which is smaller than the first sleeve bore 30, and which extends the rest of the way through the length of the exemplary sleeve 14, with the diameter reduction forming a stop 34 to limit insertion of the sleeve conduit 24 during assembly. An o-ring groove 36 formed in the face 38 of the exemplary sleeve 14 separates an inner face portion 40 from an outer face portion 42 of the sleeve body 26. The outer face portion 42 extends axially further than the inner face portion 40. On the opposite end of the exemplary sleeve 14 is an urged face 44.

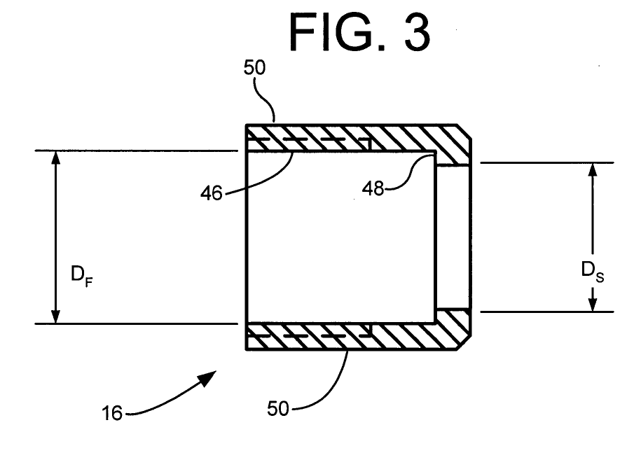

Shown in FIG. 3 is a section view of the exemplary nut 16. The exemplary nut 16 includes a first nut bore of diameter DF that is larger in diameter than a second nut bore of diameter Ds. The outermost portion of the first nut bore D_{F} has internal threads 46. At right angles to and between first bore D_{F} and second bore D_{S} is an urging face 48. The outermost portion of the exemplary nut 16 may be finished with flats 50 or other urging provisions to allow application of installation or removal torque.

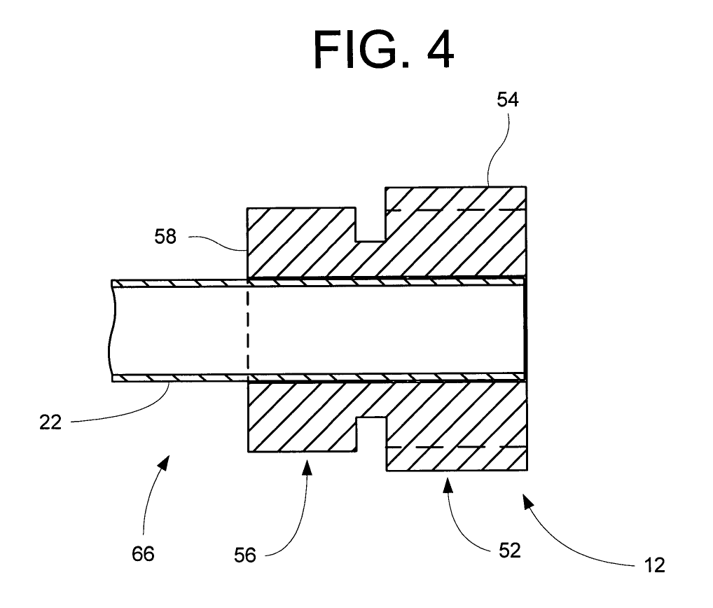

Shown in FIG. 4 is a section view of the exemplary fitting body 12 in accordance with the present invention. The exemplary fitting body 12 includes a threaded body section 52 with threads 54 and a driven body section 56. A face 58 of the threaded body section 52 forms the maximum extent of the fitting body 12. The face 58 is shown as planar and orthogonal to the axis of the exemplary fitting body 12; other contours may be used as desired. The exemplary fitting body 12 includes a bore 60 on its axis that may be identical in diameter to the first bore 30 of the sleeve 14, particularly for those embodiments in which the sleeve conduit 22 and the fitting body conduit 24 are the same size.

In using an exemplary coupling device 10 in accordance with the present invention, the exemplary fitting body 12 can be joined to the fitting body conduit 24, such as by soldering, to, for example, form a body unit 66. After placing the exemplary nut 16 onto the second conduit 24, the exemplary sleeve 14 can be similarly joined to the sleeve conduit 24, such as by soldering, to form a sleeve unit 68. In integrating the coupling device 10, the exemplary sleeve 14, with the o-ring 18 in place, is fitted against the exemplary fitting body 12, and the exemplary nut 16 is urged over the assembly and rotated to mate the fitting body threads 54 and the nut threads 46. Applying opposite torque to the flatted portions of the exemplary nut 16 and the exemplary fitting body 12 permits normal force to be applied to urge the mating faces 42 and 58, respectively, of the exemplary sleeve 14 and the exemplary fitting body 12 to establish electrical contact, simultaneously compressing the o-ring 18 against the fitting body face 58 and the o-ring groove 36 to establish a fluid-tight seal.

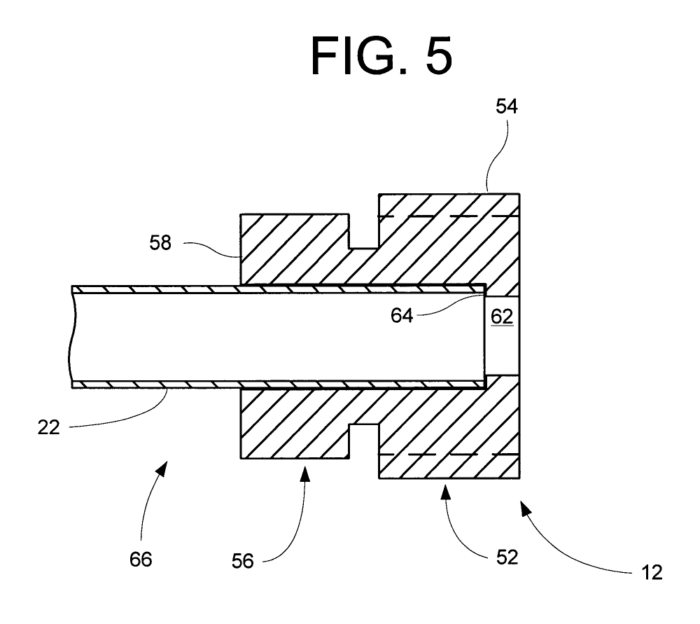

Shown in FIG. 5 is a section view of an alternate exemplary embodiment in which the first fitting body bore 60 does not extend all the way through the fitting body 12, and a second fitting body bore 62 of reduced diameter forms a fitting body conduit stop 64 in the same way that the two bores 30 and 32, respectively, in the sleeve 14 form a sleeve conduit stop 34.

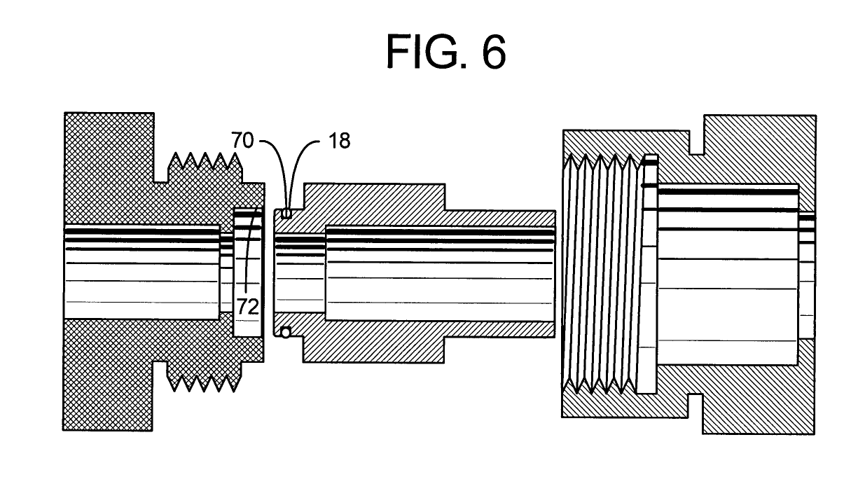

Shown in FIG. 6 is an exploded assembly section view of an alternate embodiment in which the o-ring 18 is located in a radial o-ring groove 70, and mates with a sealing face 72 that is spaced close enough to the o-ring 18 to form a fluid seal. As in the other embodiments shown, the electrical mating faces 42 and 58, respectively, are located outside the fluid seal.

Renewal of the exemplary coupling after extended use may require replacement of the o-ring 18, cleaning or refinishing the mating faces, or removing one or both mating halves and replacing them with new or refurbished pieces. Removal may be accomplished, where feasible, by desoldering a solder joint holding a fitting half to its tubing and replacing the fitting half with a like unit; by cutting off and discarding the fitting half with its internally joined conduit section and joining the new or refurbished fitting half to the shortened conduit section, or by reworking the apparatus in such other ways as may accomplish the purpose. If service life has been sufficiently extended by the use of this inventive apparatus, it may be desirable to discard all portions of the tooling.

Although the exemplary coupling device 10 is shown using tubes as the structure for the conduit feeds on both the inlet and the outlet, it will be appreciated that other feed arrangements can be used, such as a block of conductive material, for example, into which a fluid channel has been introduced, to which block the fitting body can be attached by bolting or other means.

Also, while the above exemplary embodiments illustrate a unified structure for the RF electrical current and coolant fluid portions of the induction heater device, it should be appreciated that a non-unified or hybrid approach may be devised without departing from the spirit and scope of this invention. For example, an electrically isolated, panel-mounted fitting body can have a separate coolant line and a separate RF feed line coming to it inside an induction heater station, so that the fitting body can function as an integrator of the two functions.

It will be further appreciated that the tooling can be comprised in whole or in part of a solid block equipped with fluid passages to allow fluid flow and shaped in such fashion as to provide the equivalent of one or more turns of a coil. Such a block can, for example, be built from multiple metallic pieces assembled to perform the tasks of carrying fluid and electricity, or from one or more insulating pieces to which fluid-carrying electrical conductors have been added to form a functioning assembly.

Also, although an embodiment of the coupling is shown using a joint that is urged together with helical screw threads, it will be appreciated that embodiments employing, for example, quick-release fittings, bayonet fittings, interrupted threads (breech lock fittings), clamps, Marmon bands, bolted flange fittings, and other locking mechanisms now known or future devised can be used.

In addition, it will be appreciated that the seal formed using o-ring groove 36, shown in FIG. 6 as a circumferential groove opposing an internal cylindrical face 38 of the exemplary fitting body 12 to allow a fluid seal to be established by the relative dimensions of concentric surfaces rather than being established by assembly torque, can also be realized using, in addition to the o-ring, tapered mating surfaces that draw tighter as the fitting halves are urged together. In addition, it will be appreciated that the use of a multiplicity of o-rings in separate grooves may be desirable in some embodiments. It will further be appreciated that gasket styles other than o-rings may be preferable in some embodiments. It will also be appreciated that self-sealing mechanisms can be used to retain some part of the coolant fluid after disassembly of a joint and thereby reduce both spillage and a need for coolant fluid management.

Further, while the exemplary coupling is useful for the provision of combined RF electrical current and cooling water to tooling for the induction heating apparatus, it will be appreciated that the exemplary coupling can also be used with other cooling or heating fluids to provide a combination of temperature control and alternating current (AC) or direct current (DC) electrical power in other environments where the combination can be useful, such as in using antifreeze to warm a fuel reservoir and battery power to energize an electric starter on a standby generator located outdoors.

It will also be appreciated that other materials may be used in coupling and tooling embodiments that incorporate the inventive apparatus. While a preferred conduit material, C10800 copper tubing, has exceptionally high conductivity and desirable properties for soldering, brazing, and other durable joining methods, it should be appreciated that any other bondable, electrically conductive tubing material may used, and some tubing materials may possess attributes superior to those of this copper formulation for specific tooling applications. Among these other tubing materials may be braided tubes made up of conductive wire woven over nonmetallic tubing, such as for high flex, low current applications; various steels, such as corrosion resistant (stainless) steel; copper, brass, and bronze alloys; aluminum alloys; and other materials suited to harsh or other specialized environments.

It will also be appreciated that, while some fitting materials, such as C14700 alloy and various other brasses and bronzes, may exhibit preferable fabrication and bonding properties, as well as preferable strength, chemical, and electrical properties, other possible fitting materials and finishes may be desirable in applications where manufacturability, solderability, electrical conductivity, and behavior in the presence of low-contaminant cooling water are not the principal criteria for materials selection. Examples of such environments include thermal extremes, chemical activity, repeated or continuous mechanical strain, shock and vibration, specific electromagnetic loads, food or health safety requirements, and the like.

Joining methods, which may also include welding and swaging, may preclude rework while remaining practical for some applications. For example, the exemplary embodiment shows recesses into which tubes are sweat-soldered; for some applications, butt-welding between tubes and fittings, which may have similar inside diameters, may be preferable.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A combined radio frequency electrical current and coolant fluid coupling, comprising:
a fitting body having a fitting body longitudinal axis, having a fitting body mating face generally perpendicular to said longitudinal axis of said fitting body, having a fitting body through hole generally concentric with said fitting body longitudinal axis, and having an external provision for mating;
a sleeve having a sleeve longitudinal axis, having a first sleeve mating face perpendicular to said sleeve longitudinal axis and proximal to said fitting body mating face, having a second sleeve mating face perpendicular to said sleeve longitudinal axis and distal to said first fitting body mating face, and having a sleeve through hole generally concentric with said sleeve longitudinal axis; and
a nut having a nut longitudinal axis, having an internal nut face perpendicular to said nut longitudinal axis and proximal to said second sleeve mating face when assembled, having a nut through hole generally concentric with said nut longitudinal axis, and having an internal provision for mating compatible with said external provision for mating of said fitting body.

2. The coupling fitting of claim 1, further comprising a concentric facial groove in said first sleeve mating face, of such diameter and depth as to accept an o-ring as a sealing member.

3. The coupling fitting of claim 2, further comprising an o-ring seated in said concentric facial groove.

4. The coupling fitting of claim 1, further comprising a first conduit of such size as to fit in said fitting body through hole.

5. The coupling fitting of claim 1, further comprising a second conduit of such size as to fit in said sleeve through hole.

6. The coupling fitting of claim 1, further comprising a first parallel pair of flats, integral with said fitting body, generally equidistant from said longitudinal axis of said fitting body, of such dimensions as to permit application of the torque required to urge said coupling fitting into final assembly.

7. The coupling fitting of claim 6, further comprising a first multiplicity of parallel pairs of flats, integral with said fitting body, generally equidistant from said longitudinal axis of said fitting body, of such dimensions as to permit application of the torque required to urge said coupling fitting into final assembly.

8. The coupling fitting of claim 1, further comprising a first torque application shape, integral with said fitting body, of such dimensions as to permit application of the torque required to urge said coupling fitting elements into final assembly.

9. The coupling fitting of claim 1, further comprising a first torque application shape, affixed to said fitting body, of such dimensions as to permit application of the torque required to urge said coupling fitting into final assembly.

10. The coupling fitting of claim 1, further comprising a second parallel pair of flats, integral with said nut, generally equidistant from said longitudinal axis of said nut, of such dimensions as to permit application of the torque required to urge said coupling fitting into final assembly.

11. The coupling fitting of claim 11, further comprising a second multiplicity of parallel pairs of flats, integral with said nut, generally equidistant from said longitudinal axis of said nut, of such dimensions as to permit application of the torque required to urge said coupling fitting into final assembly.

12. The coupling fitting of claim 11, further comprising a second torque application shape, integral with said nut, of such dimensions as to permit application of the torque required to urge said coupling fitting into final assembly.

13. The coupling fitting of claim 11, further comprising a second torque application shape, affixed to said nut, of such dimensions as to permit application of the torque required to urge said coupling fitting into final assembly.

14. The coupling fitting of claim 1, wherein the material comprising said fitting body and said sleeve is brass.

15. The coupling fitting of claim 1, wherein the material comprising said first conduit and said second conduit is copper.

16. The coupling fitting of claim 1, wherein the materials comprising said fitting body and said sleeve are compatible with attachment to said first conduit and said second conduit, respectively, by soldering.

17. The coupling fitting of claim 1, wherein the materials comprising said fitting body and said sleeve are compatible with attachment to said first conduit and said second conduit, respectively, by brazing.

18. The coupling fitting of claim 1, wherein the materials comprising said fitting body and said sleeve are compatible with attachment to said first conduit and said second conduit, respectively, by welding.

19. The coupling fitting of claim 1, wherein the materials comprising said fitting body and said sleeve are compatible with attachment to said first conduit and said second conduit, respectively, using a conductive adhesive.

20. The coupling fitting of claim 1, wherein electrical connectivity between said fitting body and said sleeve is established by direct pressure between said fitting body and said sleeve.

21. The coupling fitting of claim 1, wherein said fitting body and said first conduit are electroconductively and mechanically bonded and said sleeve and said second conduit are electroconductively and mechanically bonded.

22. The coupling fitting of claim 1, wherein a fluid seal between said fitting body and said sleeve is established by the seal established by direct pressure between said fitting body, said o-ring, and said sleeve.

23. The coupling fitting of claim 1, further comprising a radial groove in said sleeve, of such diameter and depth as to accept an o-ring as a seal.

24. The coupling fitting of claim 1, further comprising a coaxial surface within said fitting body, of such position, diameter, and extent as to establish a seal with an o-ring situated in a radial o-ring groove in said sleeve.

25. An apparatus and method for coupling fluid-filled conductors, comprising:
means for assembling and disassembling a fluid-filled coupling fitting first half and a fluid-filled coupling fitting second half by means of mating continuous helical screw threads;
means for establishing a low electrical resistance across a coupling interface between fluid-filled electrical conductors through the use of a normal force between mating surfaces of a fluid-filled coupling fitting first half and a fluid-filled coupling fitting second half; and
means for sealing a fluid coupling interface against fluid leakage with a gasket affixed to a fluid-filled coupling interface first half and surrounding the fluid coupling interface, where the gasket is urged against a mating surface surrounding a fluid passage in a fluid-filled coupling fitting second half.

26. The coupling fitting of claim 25, further comprising means for applying coupling torque directly to the coupling fitting first and second halves.

27. A method for coupling fluid-filled conductors, comprising the steps of:
securing a first coupling fitting half to a first conduit;
securing a second coupling fitting half to a second conduit;
placing an o-ring type gasket into a fitted groove in the first coupling fitting half;
assembling the first and second coupling fitting halves;
urging the first and second coupling fitting halves together to establish a joint with low electrical resistance and low fluid leakage.
